(19) United States
(12) Patent Application Publication
(10) Pub. No.: US 2002/0080480 A1
(43) Pub. Date: Jun. 27, 2002

(54) Illuminated crosshair plate, and telescopic sight with illuminated crosshair plate

(76) Inventor: Reimund Stingl, Ehringshausen (DE)

Correspondence Address: M. Robert Kestenbaum, 11011 Bermuda Dunes NE, Albuquerque, NM, 87111, US

(21) Appl. No.: 09/981,955

(22) Filed: Oct. 17, 2001

(30) Foreign Application Priority Data
Oct. 17, 2000 (DE) 100 51 448.0-51

(51) Int. Cl. G02B 23/00

(52) U.S. Cl. 359/424; 359/399; 359/428

(57) ABSTRACT

A target device with a crosshair plate has a target marking. Radiation emitted by a light source allocated to the crosshair plate and coupled-in to the crosshair plate, illuminates the target marking. This radiation is coupled-in to the crosshair plate from various directions.

### CROSS-REFERENCES TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The invention relates to an illuminated crosshair plate, or to a telescopic sight with an illuminated crosshair plate.

### TECHNICAL FIELD

A telescopic sight that has an illuminated crosshair plate is known from the German Utility Model G 8702309.1. In this telescopic sight, the crosshair plate is arranged in an intermediate image plane and mounted by means of a holder. This holder has an opening, through which the radiation of a light source allocated to the crosshair plate for illumination is coupled-in to the crosshair plate, through a diaphragm tube, starting from this point of the circumference. This crosshair plate is provided with etched markings or with recesses, at which the coupled-in light is reflected in the direction of the optical axis of the telescopic sight. This light field is reflected into the eye of the user of the telescopic sight, so that the user perceives this light as a target marking.

In this telescopic sight, or in this kind of illumination of the crosshair plate, it is disadvantageous that undesired reflections or flare are brought about in the whole visual field by the light coupled into the crosshair plate.

A reflection sight is known from GB 2,233,785, in which light from the environment is provided by means of a light guide running in annular form behind the objective, for the provision of an illuminated marking. This collected radiation is reflected into the eye of the observer at a partially reflecting layer which is arranged on the side of the objective lens remote from the object. This reflected light is perceived by the observer as a target marking.

### SUMMARY OF THE INVENTION

The invention has as its object to improve the illumination of the target marking or of the telescopic sight to the effect that these undesired reflections which arise are eliminated or at least reduced.

The object of the invention is attained by a sighting device having a crosshair plate with a target marking. A light source emits radiation that illuminates the target marking, and is allocated to the crosshair plate and coupled-in to the crosshair plate. The radiation is coupled-in to the crosshair plate from various directions. The object is also attained by a telescopic sight that has an eyepiece, an objective and a sighting device, according to the invention.

According to the invention, the radiation for the provision of the target marking is coupled-in to the crosshair plate in various directions, so that undesired reflections, which result from the radiation coupled-in for the provision of target marking to the crosshair plate being coupled-in from only one direction and thus having a preferred direction of propagation in the crosshair plate, no longer arise.

As a development of the invention, a light guide completely surrounds the crosshair plate, so that radiation is coupled-in to the crosshair plate from all directions.

As a development of the invention, the light guide is constituted as a one piece ring.

As a development of the invention, a radiation shield is provided at the circumference of the crosshair plate in the region in which the radiation is coupled-in to the radiation guide. This avoids having radiation that is coupled into the crosshair plate directly and not coupled into the radiation or light guide. This radiation is coupled-in to the crosshair plate via the circumferentially arranged light guide. The radiation shield is an opaque or black coat of paint.

As a development of the invention, it has been found to be advantageous to use such sighting devices, particularly in telescopes.

### BRIEF DESCRIPTION OF THE DRAWINGS

The invention is described in detail hereinafter by means of an embodiment example. In the Figures:

FIG. 1 shows a telescopic sight;

FIG. 2 shows a plan view of a crosshair plate;

FIG. 3 shows a section along A-A according to FIG. 2

FIG. 4 shows a section through the telescopic sight along A-B, according to FIG. 1.

### DETAILED DESCRIPTION OF THE INVENTION

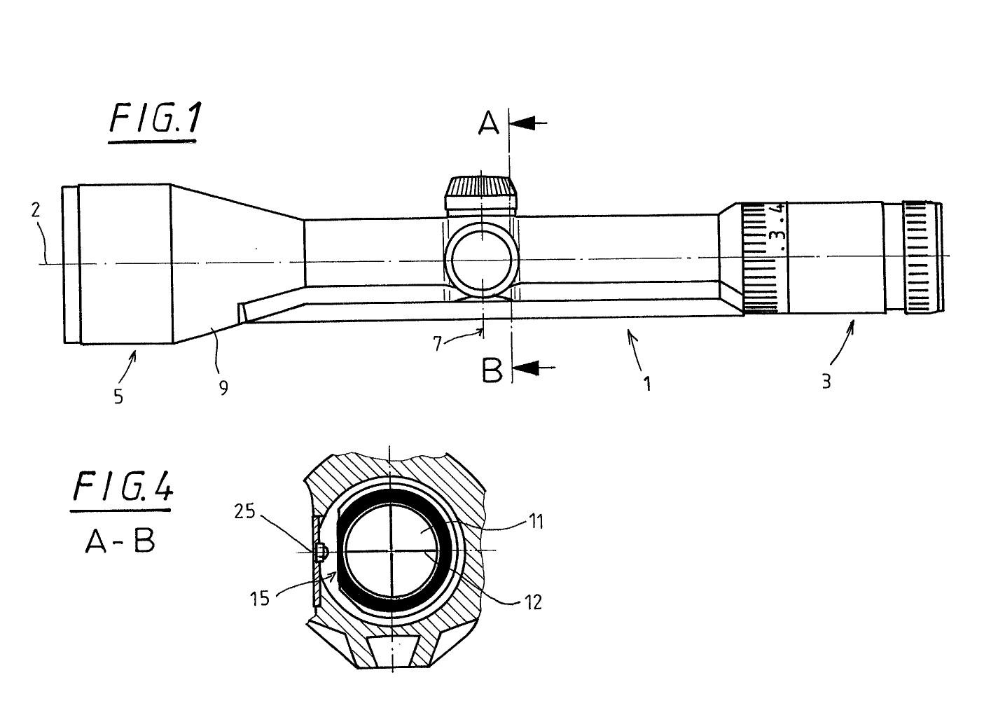

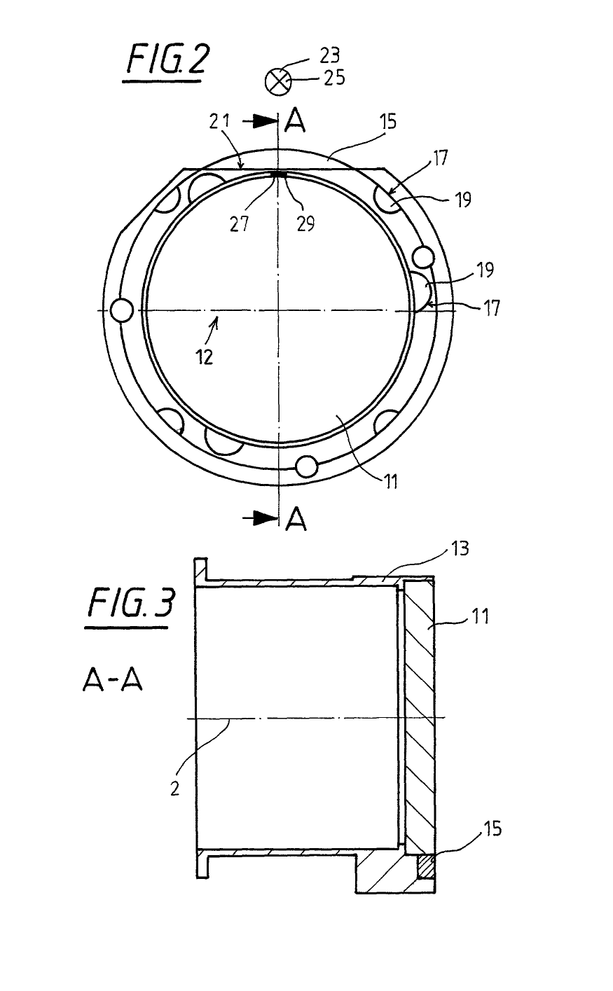

The principles of construction of a telescopic sight 1 are first described with reference to FIG. 1. The telescopic sight 1 comprises an eyepiece 3 and an objective 5, by which an optical axis 2 is defined. The eyepiece 3 and the objective 5 are mounted in a telescopic sight housing 9. An intermediate image plane 7 is defined by the eyepiece 3. A crosshair plate 11, mounted in a holder 13, is arranged in this intermediate image plane 7. Recesses are etched in this crosshair plate 11 to form a target marking 12. As shown in FIG. 2, the crosshair plate 11 is surrounded coaxially by a light guide 15, the light guide 15 and the crosshair plate 11 being securely connected together. To connect them, grooves 17 for UV cement 19 are formed in the light guide 15. The secure connection of the crosshair plate 11 and the light guide 15 is ensured by this UV cement 19. As will be apparent particularly from FIGS. 3 and 4, the light guide 15 is embedded in the holder 13 of the crosshair plate 11. The holder 13 of the crosshair plate 1 1 is provided with a bevel 21, so that in this region the light guide 15 is not surrounded at its radial outer circumference by the holder 13 of the crosshair plate 11. The radiation of a light source 23, in particular of a diode 25, is coupled-in in this region. A beam shield 27, which in this embodiment example is constituted as a blackening 29, is provided in this region between the light guide and the crosshair plate, and prevents direct radiation entry into the crosshair plate. The radiation of the light source 23 is coupled-in to the light guide 15 in the region of the bevel 21. The occurrence of reflections is prevented by means of the nearly uniform coupling-in of the radiation over the whole circumference of the crosshair plate.

I claim:

1. A sighting device comprising:
a crosshair plate having a target marking,
at least one light source emitting radiation that illuminates said target marking, wherein said radiation is coupled into said crosshair plate from various directions.

2. The sighting device according to claim 1, further comprising a plurality of said light sources distributed at a circumference of said crosshair plate,
wherein said radiation is provided from said plurality of light sources.

3. The sighting device according to claim 2, wherein said plurality of light sources comprises at least three light sources.

4. The sighting device according to claim 1, wherein said radiation is coupled-in spread out over a circumference of said crosshair plate.

5. A sighting device comprising:
a crosshair plate having a target marking, at least one light source emitting radiation that illuminates said target marking,
wherein a light guide is arranged circumferentially to said crosshair and is connected to a circumferential surface of said crosshair.

6. The sighting device according to claim 5, wherein said light guide surrounds said crosshair plate.

7. The sighting device according to claim 5, further comprising a radiation shield on said circumference of said crosshair plate in a region in which said radiation is coupled-in to said light guide.

8. The sighting device according to claim 7, wherein said radiation shield comprises an opaque coat of paint.

9. The sighting device according to claim 5, wherein said light guide comprises a one piece ring.

10. A telescopic sight comprising
an eyepiece,
an objective, and
a sighting device according to claim 1.
